(19) United States
(12) Patent Application Publication
(10) Pub. No.: US 2018/0195344 A1
(43) Pub. Date: Jul. 12, 2018

(54) Motorized Ladder Leveler

(71) Applicant: W. John Wilkinson, Calgary (CA)

(72) Inventor: W. John Wilkinson, Calgary (CA)

(21) Appl. No.: 15/402,430

(22) Filed: Jan. 10, 2017

(51) Int. Cl. E06C 7/44

(52) U.S. Cl. CPC E06C 7/44

(57) ABSTRACT

A ladder leveler features at least one linear actuator with a respective electric motor operable to drive extension and retraction of an output shaft of the actuator, a distal end of which carries a respective ground foot. Each actuator is attached or attachable to a respective side rail of the ladder in a position placing the respective foot proximate a lower end of the side rail when in a retracted position. Under operation of the actuator in an extending direction, the output shaft drives the foot downwardly past the bottom end of the side rail to effectively lengthen the bottom end of the side rail. At least one battery is mounted or mountable to said ladder and connected or connectable to said electric linear actuators to control extension and collapse thereof, and a wired/wireless control system is operable to control extension and retraction of the first and second linear actuators.

### FIELD OF THE INVENTION

The present invention relates generally to ladders and accessories for same, and more particularly to a ladder leveling apparatus employing motorized electric actuators to selectively extend the bottom end of one side rail of a ladder relative to the other to ensure a level orientation of the ladder when used on sloped uneven surfaces.

### BACKGROUND

Various ladder leveling apparatuses have been proposed in the prior art for the purpose of establishing a safe, level ladder position when used on sloped or uneven surfaces. Examples of such apparatuses are found in U.S. Pat. Nos. 2,971,602, 4,673,061, 5,044,468, 5,816,364, 7,774,950, 8,011,473, 8,360,204, and U.S. Pat. No. 9,322,215; U.S. Patent Application Publications 2008/0078616 and 2014/0083799; Canadian Patent Application CA2825179; and International PCT Publication WO2014/083221.

However, there remains room for improvement, and Applicant has developed a unique ladder levelling solution with advantages and beneficial features not heretofore seen.

### SUMMARY OF THE INVENTION

According to one aspect of the invention there is provided a ladder leveling apparatus for a ladder comprising a pair of side rails and a series of rungs spanning between said side rails at spaced intervals therealong, said leveling mechanism comprising:

at least one electric linear actuator comprising a respective electric motor operable in opposing directions to drive extension and retraction of an output shaft of said electric linear actuator to which a respective ground engagement foot is attached at a distal end of said output shaft, said at least one electric linear actuator being attached or attachable to a respective side rail of the ladder in a position placing the respective ground engagement foot proximate a lower end of the respective side rail when the respective output shaft is in a retracted position, such that extension of the output shaft from said retraced position displaces the ground-engaging foot downwardly past the lower end of the respective side rail;

at least one battery unit mounted or mountable to said ladder and connected or connectable to said at least one electric linear actuator to control extension and collapse thereof; and

a control system operable to control extension and retraction of the at least one linear actuators.

In some embodiments, the control system comprises at least one wired or wireless control respectively mounted or mountable to said respective side rail of the ladder and connected or connectable in a control circuit with said at least one battery unit and said at least one electric linear actuator to control extension and retraction thereof.

In some embodiments, the control system comprises at least one momentary rocker switch with a neutral off position, and two momentary on positions corresponding to extension and retraction of the electric linear actuators.

In some embodiments, said at least one control is mounted to the respective side rail of the ladder at an exterior side thereof opposite the rungs.

In some embodiments, said at least one control is mounted to the respective side rail of the ladder at a location nearer to the bottom end of the side rail than to an opposing top end thereof.

In some embodiments, said at least one control is mounted to the respective side rail of the ladder at a location within six feet of the bottom end thereof.

In some embodiments, said at least one battery unit is mounted to a respective rung of the ladder.

In the instance of a rung-mounted battery unit, said battery unit may comprise support straps for closure around a respective rung of the ladder to mount said at least one battery unit to said respective rung in a position therebeneath.

In the instance of a rung-mounted battery unit, said battery unit may be mounted to said respective rung in a position residing beneath said respective rung and leaving a topside thereof unobstructed for stepping access thereto by a user.

In the instance of a rung-mounted battery unit, control circuit wiring from said at least one battery unit to said at least one electric linear actuator may extend from said battery unit along the respective rung to the respective side rail of said at least one electric linear actuator.

In such instance, said control circuit wiring may run upwardly along an inner side of said respective rail from said respective rung.

In some embodiments, said at least one electric linear actuator is coupled to the respective side rail of the ladder at an exterior side thereof by at least one U-bolt embracing around a housing of said electric linear actuator.

In one embodiment, the at least one electric linear actuator comprises a pair of electric linear actuators that are respectively coupled to the side rails of the ladder at exterior sides thereof opposite the rungs, and are coupled together by a threaded rod passing internally through a hollow rung of the ladder.

In other embodiments, one or more quick-attach mechanisms are associated with the at least one electric linear actuator and operable for releaseable attachment thereof to the respective side rail of the ladder.

In such embodiments, said one or more quick-attachment mechanisms preferably comprise a rung-insert removably insertable into a hollow interior of a respective rung of the ladder.

In such instance, said at least one electric linear actuator may comprise a pair of electric linear actuators that are respectively coupled to the side rails of the ladder and each have a respective quick attach mechanism with a respective rung insert, in which case a length of each rung-insert may be less than half a rung-width of said ladder to enable insertion of the rung-inserts of the quick-attach mechanisms into a same rung from opposing ends thereof.

Preferably, said rung-insert is selectively expandable and collapsible in a radial direction to enable attachment of the at least one electric linear actuator to the respective rung by insertion of the rung-insert into said respective rung, and radial expansion of said rung-insert once inside said respective rung to frictionally engage with internal wall surfaces of said respective rung.

In some embodiments, the at least one control is respectively connected to the at least one linear actuator by a flexible cord or wireless connection allowing selective mounting of the control at a user selectable position along the respective side rail.

In some embodiments, said at least one electric linear actuator comprises a pair of electric linear actuators that are respectively coupled to the side rails of the ladder and said at least one battery unit comprises a pair of batteries respectively attached to, our housed together with, the pair of electric linear actuators, whereby mounting of said pair electric linear actuators to the side rails of the ladder also mounts the batteries to said rails of the ladder.

In some embodiments, the control system comprises a remote control operable to send control signals to the first and second linear actuators for wireless control thereof at a distance from the ladder.

### BRIEF DESCRIPTION OF THE DRAWINGS

Preferred embodiments of the invention will now be described in conjunction with the accompanying drawings in which:

FIG. 1 is a perspective view of a ladder equipped with a leveling apparatus according to a first embodiment of the present invention.

FIG. 2 is a front elevational view illustrating use of the ladder of FIG. 1 on uneven surfaces, where the leveling apparatus extends one side rail of the ladder downward to a lower one of the two uneven surfaces, thereby providing the ladder with a level stable position for safe use.

FIG. 3 is an exploded perspective view illustrating installation of an extension/retraction unit of a quick-attach ladder leveling apparatus according to a second embodiment of the present invention.

FIG. 4 is a partial view of the quick-attach extension/retraction unit of FIG. 3 as partially sectioned along line A-A thereof.

FIG. 5 is a partial view of a first variant of the quick-attach extension/retraction unit of FIG. 4.

FIGS. 6A and 6B are partial views of a second variant of the quick-attach extension/retraction unit of FIG. 4, in radially collapsed and expanded states respectively.

FIGS. 7A and 7B are partial views of a third variant of the quick-attach extension/retraction unit of FIG. 4, in radially collapsed and expanded states respectively.

FIG. 8 is an exploded perspective view illustrating installation of an extension/retraction unit of a bolt-on ladder leveling apparatus according to a third embodiment of the present invention.

FIG. 9 is an exploded perspective view illustrating a variant of the bolt-on ladder leveling apparatus of FIG. 8.

In the drawings like characters of reference indicate corresponding parts in the different figures.

### DETAILED DESCRIPTION

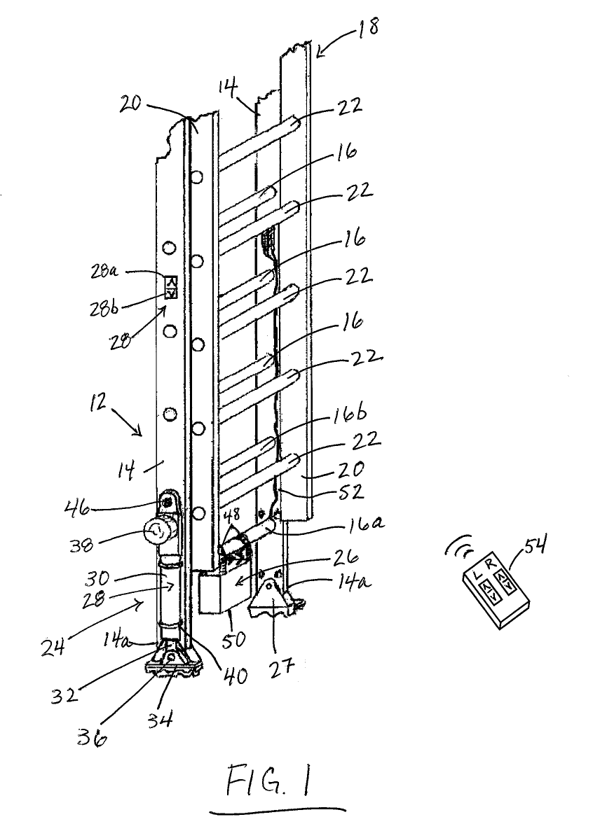

FIG. 1 illustrates a ladder that incorporates a levelling apparatus according to one embodiment of the present invention. In the illustrated example, the ladder 10 is an extension ladder having a main section 12 and an extension section 18. The main section is made up of parallel first and second upright side rails 14 with a plurality of horizontal rungs 16 spanning therebetween at regularly spaced intervals along the side rails. The extension section 18 likewise made up of a parallel pair of side rails 20 with a series of horizontal rungs 22 spanning therebetween at regular intervals. The extension section 18 is slidably coupled to the main section 12 for sliding movement of the extension section's side rails 20 up and down the side rails 14 of the main section. The extension section 18 is shown in a lowered position placing its rungs even with the rungs of the main section 12, but is raiseable into an elevated position where most or all rungs of the extension section 18 are situated above the uppermost rung of the main section 12 in order to effectively extend the height of the ladder. Such extendable ladder construction is well known, and thus not described herein in further detail. In the present embodiment, the leveling apparatus of the present invention is installed on the main section of the extension ladder, but may be installed in the same manner on a two-rail non-extendable ladder, or on the four rails of a step ladder. Accordingly, reference made herein below to the side rails and rungs is in relation to those of the main section of the illustrated ladder, not those of the extension section.

The levelling apparatus is primarily made up of two extension/retraction units 24 respectively attached to the side rails 14 of the ladder, a battery unit 26 mounted to the lowermost rung 16a of the ladder, and a pair of controls 28 respectively mounted to the side rails 14 at locations higher up the ladder from the rail-mounted extension/retraction units 24 and rung-mounted battery unit 26.

Each extension/retraction unit features an electrically powered linear actuator 28 with an elongated housing 30 and an extendable/retractable output shaft 32. The output shaft 32 reaches outward from the cylindrical housing 30 at a lower end thereof that resides in close proximity to the bottom end 14a of the respective side rail 14 of the ladder. In the illustrated embodiment, the ladder features two pivotal feet 27 respectively coupled to the side rails 14 in a manner pivotal relative thereto about a shared horizontal axis parallel to the rungs 16, as is common in the art. The lower end of the output shaft 32 of each linear actuator 28 has a secondary ground engagement foot 34 coupled thereto by a respective pivot pin 36, whereby the secondary ground engagement foot 34 is likewise pivotable about a horizontal axis parallel to the rung direction of the ladder. Each linear actuator 28 is of a known commercially available type, which features an electric motor 38 operable to rotatably drive a screw mechanism located inside the cylindrical housing 30 on a longitudinal axis thereof, while an internally threaded portion of the output shaft 32 is threaded on the screw mechanism. Driven rotation of the screw mechanism in opposing directions by the motor 38 drives longitudinal displacement of the output shaft 32 back and forth along the longitudinal axis of the housing 30. These actuators include limit switches that automatically terminate operation of the motor once the output shaft has reached a predetermined travel limit in either direction.

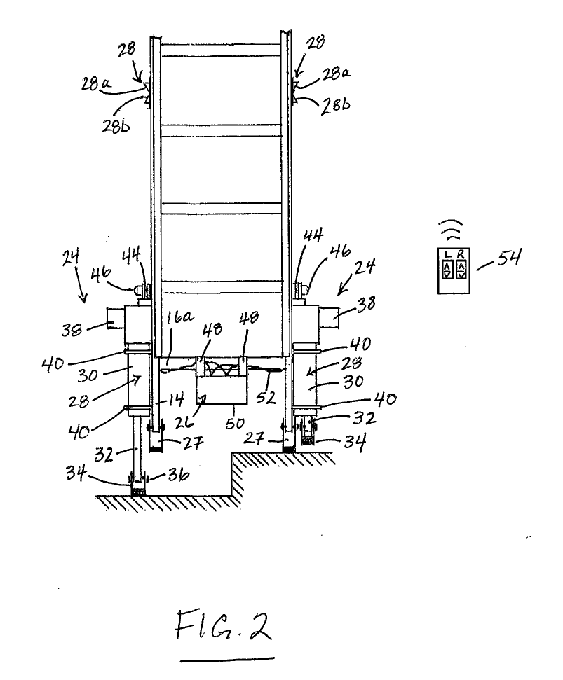

In a fully retracted position of the output shaft 32, shown in FIG. 1, the bottom of the secondary ground engagement foot 34 resides slightly above the bottom of the primary foot 27 on the respective side rail 14 of the ladder. Accordingly, with both linear actuators 28 fully retracted, the ladder will stand on the primary feet 27 of its side rails 14 in a conventional manner. On the other hand, extension of either linear actuator 28 to drive its output shaft 32 downwardly from the bottom end 14a of the respective side rail 14 will drive the secondary ground engagement foot 34 downwardly past the primary foot 27 to effectively extend the bottom end of the side rail. FIG. 2 shows an exemplary use of the levelling apparatus, where the linear actuator on the left side of the ladder is extended in order to reach down to a lower one of two uneven ground surfaces, for example on a stairway. This side of the ladder is accordingly supported by the secondary ground engagement foot 34. On the other hand, the linear actuator on the right side of the ladder kept in its normal retracted position so that the primary foot 27 of the right side rail supports this side of the ladder on the higher ground surface.

Each linear actuator is clamped against the outer side of the respective side rail, i.e. the side of the side rail facing away from the rungs of the ladder. For such purposes, by a pair of U-bolts 40 embrace around the cylindrical housing 30 of the actuator 28 near the top and bottom ends thereof, and are fastened through drilled holes in the respective side rail 14 of the ladder. In addition to this, further mounting of each extension/retraction unit to the ladder is achieved by a threaded rod 42 that passes through the second lowest rung 16b of the ladder so that the two ends of the threaded rod 42 reach through respective brackets 44 fixed atop the upper ends of the two linear actuators 28. A pair of nuts or threaded caps 46 are tightened onto the ends of the threaded rod 42. The U-bolts and the nuts or caps 46 on the threaded rod 42 thus clamp the two extension/retraction units 24 against their respective side rails of the ladder, while the threaded rod 42 passing through the respective rung 16b of the ladder prevents either of the extension/retraction units from sliding down the respective side rail. This combination of clamping the units 24 to the side rails and hanging them from the respective rung 16b ensures secure attachment to the ladder.

The battery unit 26 features at least one battery B, for example a single 12V battery, which may be rechargeable, and a pair of straps 48 fastened to either the battery itself or to an enclosure 50 in which the battery is contained. The straps are slung over and tied around the lowermost rung 16a of the ladder in order to secure the battery to the lowest rung 16a in a position suspended therebeneath. By attaching the battery unit to a rung of the ladder, the added weight of the battery B can be centered between the two side rails 14 of the ladder to maintain a balanced weight distribution of the overall assembly. This balanced weight is likewise maintained by use of two identical extension/retention mechanisms mounted in the same positions on the two side rails. Mounting the battery unit beneath the rung keeps the topside of the rung 16a open for unobstructed step access by the ladder user. Support of the battery on the lowest rung also keeps it from interfering with insertion and withdrawal of the climber's feet between the inter-rung spaces further up the ladder, and also helps contribute to a lower center of gravity for the overall assembly, thus improving the stability of same.

Each control 28 is operable over a respective one of the two linear actuators 28, and is mounted on the same side rail of the ladder as said respective actuator at a spaced distance further upward on the ladder. The control 28 is preferably placed at a height along the side rail 14 that is conveniently reachable by an average user when standing at ground level in front of the ladder, whereby adjustment of the ladder using the leveling apparatus is easily achievable before climbing onto the ladder. This way, the stability of the ladder is achieved before the user exerts any body weight on the ladder rungs, thus optimizing user safety. In preferred embodiments, the controls 28 are within six feet of the lower ends of the side rails, and may be located nearer to the lower ends of the side rails than to the top ends thereof, or at least closer to the bottom ends of the main section side rails than to the top ends of the extension section sides rails in the scenario of an extended extension ladder. In select embodiments, the controls are within five feet, or even four feet, of the lower ends 14a of the side rails 14 to ensure convenient comfortable access from ground level for users of varying height.

Each control 28 in the illustrated embodiment is a momentary rocker switch wired or wirelessly connected in a control circuit between the battery and the respective linear actuator thereof. The switch has a neutral ‘off’ position disconnecting the battery from the actuator. The rocker is placed in an upright orientation, where depression of its upper surface rocks the switch into a momentary “retraction on” position, which applies the correct polarity to the linear actuator to drive retraction thereof and raising of the secondary foot 34. On the other hand, depression of the switch's lower surface rocks the switch into a momentary “extension on” position, which applies the correct polarity to the linear actuator to drive extension thereof and lowering of the secondary foot 34.

By use of a momentary switch, safety is improved by not requiring a separate user input to turn off the actuator, as mere release of the switch will return the switch to its neutral “off” position, and thereby terminate any movement of the respective actuator. As shown, the upper surface 28a of the switch is preferably labelled with an “up” arrow, denoting the upward actuator retraction caused by depression thereof, while the lower surface 28b of the switch is preferably labelled with a “down” arrow, denoting the downward actuator extension caused by depression thereof. Additional text-based labelling of the switch may also be included, but at minimum, inclusion of arrow-based or other symbolic labelling is preferred to provide universally understood meaning regardless of the user's language or literacy.

The control circuitry includes wiring 52 spanning from the battery unit 26 along the lowermost rung 16 toward either side rail, and then up the inner side of each side rail to the respective linear actuator 28 and switch control 28 mounted externally thereon. Routing of the wiring up the inner side of the rail 14 reduces the likelihood of it catching on a user's hand or other object during transport or use of the ladder. Alternatively the mounted switch control 28 may operate wirelessly to reduce the amount of wiring required on the inner rail 14.

The control circuit may include a wireless receiver R, for example contained within the same enclosure 50 as the battery B. The receiver is configured to receive remote control signals from a wireless remote control 54 capable of providing the same “on extension” and “on retraction” signals as the ladder's on-board controls 28. The remote control may likewise use two momentary rocker switches each having up and down arrows, and respectively labelled or logically positioned according to which switch controls which actuator. The illustrated example uses an “L” label at the left switch of the remote to designate that it controls the actuator on the left side of the ladder, and an “R” label at the right switch of the remote to designate that it controls the actuator on the right side of the ladder. Similar labelling may be provided on the ladder or the extension/retraction units to explicitly label to the two sides of the ladder in a distinctive manner from one another. While the illustrated embodiment employs both on-board controls 28 and a wireless remote control 54, one or the other may optionally be omitted, through the inclusion of on-board controls provides a redundant backup in the event of a lost remote control, or a depleted remote control battery. While the illustrated embodiment features a dedicated remote control, in other embodiments the remote control may be a programmable or general purpose device with a suitable transmitter/transceiver, for example a smart phone with a Bluetooth transceiver or other short-range transceiver compatible with a matching receiver/transceiver type of the ladder levelling apparatus.

The control circuitry may optionally include a tilt sensor and cooperating circuitry operable to extend an appropriate one of the linear actuators according to the detected direction of ladder tilt, and to proportionally extend the actuator by the appropriate amount to overcome the degree of tilt detected. In such embodiments with self-levelling control circuitry, the manual on-board control 28 and wireless remote control 54 may be omitted.

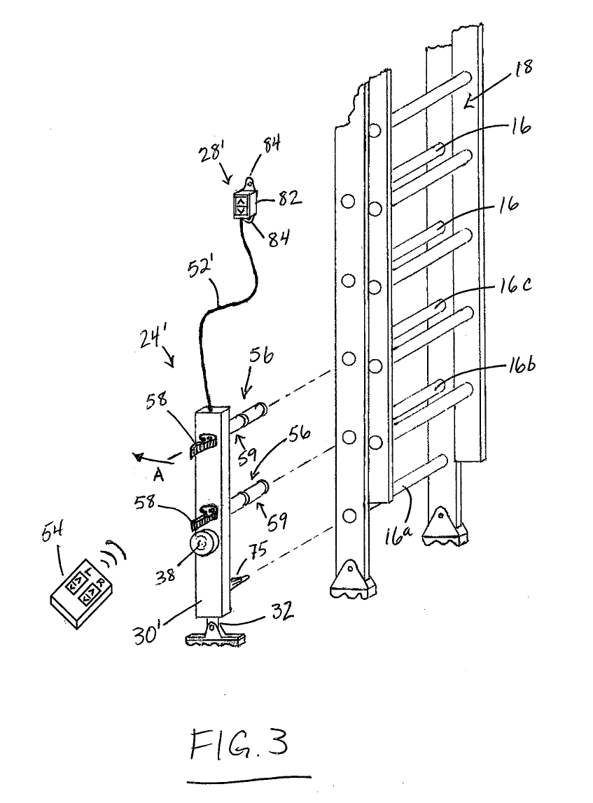

The first illustrated embodiment is based on a prototype of the invention retrofitted onto a conventional off-the-shelf extension ladder. It will be appreciated that more integral incorporation of the levelling apparatus into the ladder construction during factory assembly may involve several modifications from the illustrated embodiment, for example including internal mounting of components of the extension/retraction units into hollow side rails of the ladder, routing of control circuit wiring internally through the side rails and/or rungs, and incorporation of the battery and control circuit componentry into the side rails and/or rungs, etc.

Whereas the fastening of the extension/retraction units to the ladder in the manner taught by the first illustrated embodiment requires multiple steps to install or remove each such unit from the ladder, thus representing a generally permanent or semi-permanent installation not intended for removal by the end user, the second illustrated embodiment shown in FIG. 3 provides for simpler installation on an existing ladder using a unique quick-attach arrangement for each extension/retraction unit.

Instead of having a separate battery unit 26 shared by the two extension/retraction units 24, the embodiment of FIG. 3 instead provides each extension/retraction unit 24′ with an enlarged housing 30′ that not only contains the screw mechanism of the linear actuator and the geared connection thereof to the motor 38, but also contains the battery B and optional wireless receiver R. This larger housing 30′ reaches further upwardly along the respective side rail 14 to carry a pair of quick-attach mechanisms 56 at locations above the motor 38 of the linear actuator. Each quick attach 56 features a quick release skewer whose cam-lever 58 is situated at an outer side of the housing 30′. An opposing inner side of the housing 30′ abuts against the exterior side of the respective side rail of the ladder in the installed position of the unit 24′. Directly across from the cam-lever 58, a rung-insert 59 of each quick-attach mechanism projects perpendicularly from the inner side of the housing 30′.

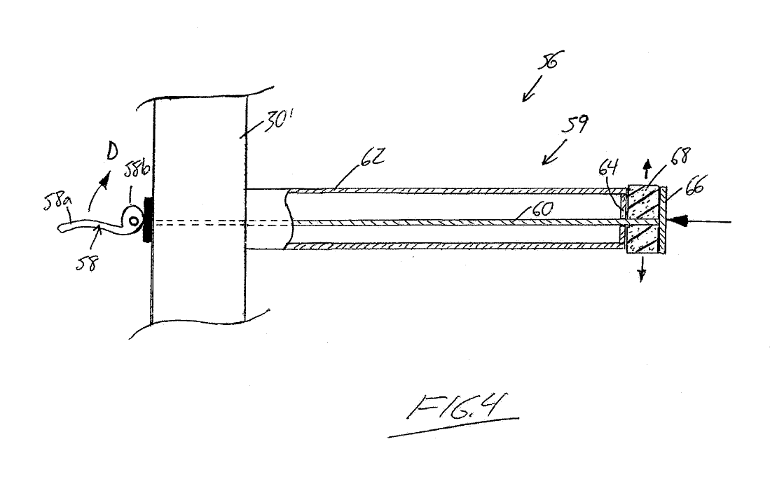

With reference to the partially cross-sectioned view of FIG. 4, each rung insert 59 features a rigid tubular member 62 through which the linear rod 60 of the quick release skewer extends on a central longitudinal axis of the tubular member 62. Outside the tubular member 62 beyond a capped distal end 64 thereof opposite the housing 30′, the skewer rod 60 carries a clamping plate 66 that lies perpendicularly to the rod 60 at the free end thereof. Between the clamping plate 66 and the capped distal end 64 of the tubular member is a resiliently compressible and expandable packing 68 of rubber or other resilient material. The linear rod 60 of the quick release skewer is coupled to the cam lever 58 thereof, whereby from the illustrated open or release position in which a lever handle 58a of the cam lever lies generally longitudinally out the rod 60, pivoting of the cam lever 58 in a tightening or closing direction D turns a lobed camming area 58b of the cam lever 58 toward the outer side of the housing 30′. As a result of the camming action of the lever's lobed area 58b against the outer side wall of the housing 30′, the cam lever 58 pulls on the skewer rod 60, which in turn pulls the clamping plate 66 tighter against the rubber packing 68. This causes the packing 68 to undergo axial compression against the capped distal end 64 of the tubular member, during which the rubber packing radially dilates to force the outer perimeter of the packing radially outward from the longitudinal axis of the skewer rod 60. The undilated diameter of the packing 68 is closely comparable to the internal diameter of the ladder's hollow rungs, which in turn is slightly greater than the outer diameter of the tubular member 62 of the rung insert 56. This allows manual insertion of each rung insert into a hollow rung of the ladder.

With reference to FIG. 3, with the cam lever of each quick release skewer in its open/released position, and the respective packing 68 thus being in an axially uncompressed state, each rung insert 56 of the extension/retraction unit 24′ is slid axially into a respective one of the ladder's second or third rungs 16b, 16c, as allowed by the natural undilated diameter of the packing that don't exceed the internal rung diameter. Each rung insert 56 is slid into the respective rung through the open end thereof at the side rail of the ladder by pushing the housing 30′ toward the side rail 14, until the housing 30′ comes into abutment against the outer side of the side rail 14. At this point of full insertion, each cam lever 58 is then pivoted in the tightening direction D into an over-center closed position in which the achieved axial compression and resulting radial dilation of the packing 68 is such that the outer periphery of the packing radially expands into tight frictional abutment against the internal wall surfaces of the hollow ladder rung. This frictional lock thus holds the rung insert 56 against withdrawal from the rung. Installation of the extension/retraction unit 24′ thus requires only manual insertion of the rung inserts 56 into the respective rungs 16b, 16c of the ladder by manual displacement of the housing 30′ toward the side rail, followed by closure of the two cam levers 58 into their tightened, over-center positions.

Although FIG. 3 shows only one of the two extension/retraction units 24′, an identical second unit may be installed in the same manner at the opposing side of the ladder. To enable the rung inserts 56 of the two extension/retraction units 24′ to simultaneously occupy the same rungs 16b, 16c, each rung insert 56 has an axial length measured from the inner side of the housing to the distal clamping plate 66 that is less than half of the rung-width measured between the outer sides of the two side rails of the ladder. The two rung inserts reaching into the same rung from the housings of the two different extension/retraction units thus reside end-to-end with one another inside the respective rung when the two extension/retraction units are installed. Removal of the extension/retraction units is just as simple, requiring only opening of the cam levers 58 to their release positions, thus allowing the resilient packings 68 to return to their axially uncompressed and radially undilated states, whereupon the rung inserts 56 can be drawn out from the ladder rungs 16b, 16c by pulling the housings 30′ of the two extension/retraction units 24′ away from the respective side rails 14 of the ladder. The FIG. 3 embodiment is thus easily added and removed to and from any hollow-rung ladder.

With two radially expanding/dilating rung inserts holding each extension/retraction unit 24′ against lateral withdrawal from the side of the ladder, and cooperating together to prevent any pivoting of the unit about one of the rung axes, a third rung insert may not be required. However, FIG. 3 illustrates optional inclusion of another non-expanding insert 75 located fully to the inner side of the housing 30′ further down below the motor 38 for insertion into the lowermost rung 16a for additional stability against tilting of the housing 30′ relative to the side rail of the ladder.

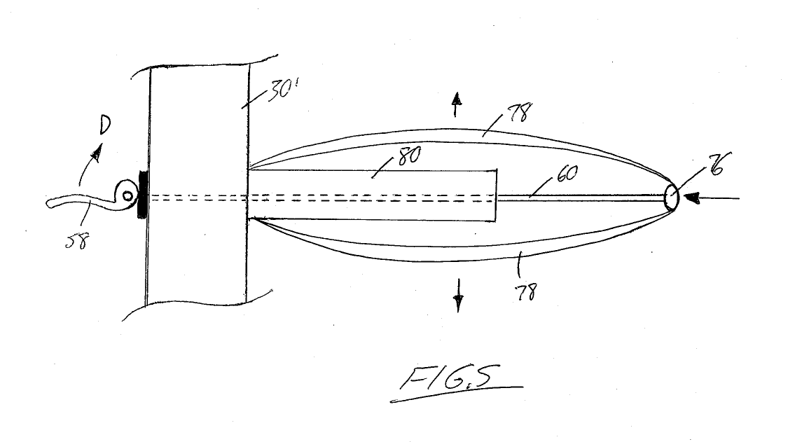

FIG. 5 shows a variation on the radially expandable rung insert of FIGS. 3 and 4, where instead of a clamping plate that axially compresses a resilient packing in order to radially dilate same, the skewer rod 60 has a head 76 at its distal end to which a plurality of resiliently flexible metal bands 78 or ribbons each have one end affixed. The other ends of the metal bands are affixed to the inner side of the housing 30′, or to a guide shaft 80 that is fixed to the inner side of the housing 30′ and through which the skewer rod 60 axially extends for guided linear motion through an axial through-bore of the shaft 80. Accordingly, one end of each metal band is affixed to the movable skewer rod 60, while the other end is rigidly fixed to the housing 30′. In the default state, the bands 78 each have a bowed shape, the concave side of which faces the skewer rod 60. Under pulling of the skewer rod 60 by closing of the cam lever 58 in the tightening direction D, the head 76 of the skewer rod is drawn toward the housing 30′, thus pulling the rod-attached distal ends of the metal bands 78 toward their opposing housing-attached proximal ends. This causes the bands 78 to bow further outward from the skewer rod 60.

In their relaxed states, the radial distance of each metal band from the skewer rod axis is comparable or even slightly larger than the inner radius of the hollow ladder rung, but because of their flexible nature allows insertion and withdrawal of the rung insert to and from the ladder rung when the cam lever is opened to its release position. Closing the cam lever to its over-center tightening position increases the radial extent of each band 78 to a value significantly exceeding the inner radius of the rung. Closing of the cam lever with the rung insert inside the hollow rung thus expands the metal bands 78 into increased frictional engagement against the inner wall surfaces of the hollow rung, thereby securing the rung insert and the attached remainder of the extension/retraction unit in place on the ladder.

The controls 28′ of the FIG. 3 embodiment feature respective switch housings 82 with screw holes in one or more fastening flanges 78 to enable fastening of the switch housing to the outer side of the respective side rail 14 of the ladder using metal screw fasteners. Alternatively or additionally, an adhesive backing may be provided on a back of the switch housing 82 for adhesive bonding thereof to the side rail 14 of the ladder. A flexible cord 52′ with the control circuit wiring exits the housing 30′ at the top end thereof and connects to the control 28′, which can therefore be attached to the ladder rail at any user-selectable height therealong according to the comfort of the ladder owner or user. As shown, a wireless remote control 54 may once again be included in addition to, or in replacement of, the ladder-mountable controls 28.

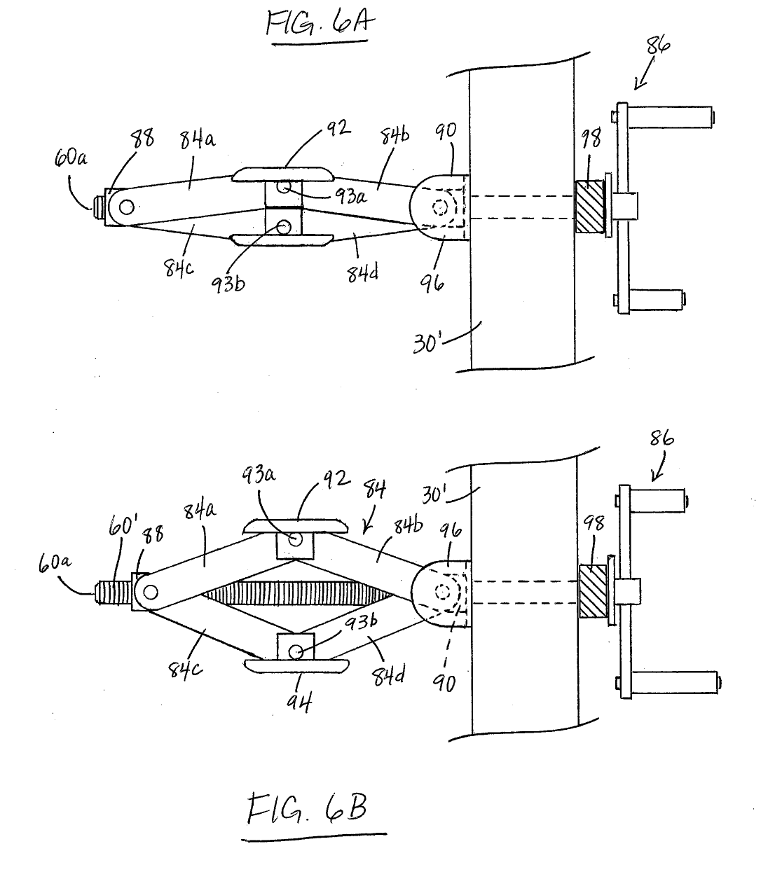

FIGS. 6A and 6B show another variation on the radially expandable rung insert, wherein instead of a compressible packing or flexible metal bands on an axially displaceable skewer rod, a scissor linkage 84 is cooperatively installed on a rotatable threaded rod 60′ that passes through the housing 30′. At the outer side of the housing 30′, the threaded rod 60′ is attached to a rotatable crank handle 86 by which the threaded rod 60′ can be rotatably driven about its central longitudinal axis. On the opposing inner side of the housing 30′, an internally threaded nut or sleeve member 88 is threaded on the rod 60′ near the free end 60a thereof furthest from the housing 30′.

One half of the scissor linkage features a first link 84a pivotally pinned to the internally threaded member 88 at one end, and reaching toward the housing 30′. The opposing end of the first link 84a is pivotally pinned to one end of a second link 84b, which continues to reach along the threaded rod 60′ further toward the inner side of the housing 30′. The opposing end of the second link 84b nearest the housing is pivotally pinned to a non-threaded sleeve or collar member 90 closing around the threaded rod 60′. The non-threaded member 90 has a smooth-walled inner bore of greater diameter than the threaded rod 60 so that relative rotation and axial displacement can occur between the threaded rod 60′ and the non-threaded member 90.

A second half of the scissor linkage similarly features a third link 84c with one end pivotally pinned to the internally threaded member 88, and a fourth link 84d with one end pivotally pinned to the third link and the other end pivotally pinned to the non-threaded member 90. The pivot pins of the linkage all lie parallel to one another, and perpendicular to the longitudinal axis of the threaded rod 60′. A first grip pad 92 is coupled to the linkage at the pivot point 93a between the first and second links, and a second grip pad 94 is likewise coupled to the linkage at the pivot point 93b between the third and fourth links. Each grip pad faces outwardly away from the linkage, i.e. radially outward from the threaded rod 60′.

FIG. 6A shows the linkage 84 in a radially collapsed condition, where the four links all lie nearly parallel to the threaded rod 60′, thus placing the grip pads 92, 94 in close radial proximity to the rod 60′. This represents a radially collapsed condition of the rung insert. Rotating the crank 86 in a predetermined direction advances the internally threaded member 88 toward the inner side of the housing 30′, thus drawing this distal end of the linkage toward the housing 30′. If the non-threaded member 90 is not initially in firm contact with the inner side of the housing 30′, the initial axial displacement of the threaded member 88 toward the housing will displace the entire linkage 84 toward same. However, once the non-threaded member 90 is in firm contact against the inner side of the housing 30′, continued rotation of the threaded rod 60′ via the crank 86 will draw the threaded member 88 and associated distal end of the linkage toward the non-threaded member 90 at the opposing proximal end of the linkage. This axial contraction of the linkage 84 along the axis of the threaded rod 60′ causes the pinned-together pad-carrying ends of the links to pivot away from the rod 60′, thus forcing the pads 92, 94 radially outward from the rod 60′. To prevent the linkage from rotating about the axis of the threaded rod 60′, a pair of stop flanges 96 are affixed to the housing 30′ to project from the inner side thereof on opposing sides of the linkage at the proximal end thereof.

To use this scissor-based quick-attach rung insert, scissor linkage of the rung insert is inserted into a hollow ladder rung in the radially collapsed state of FIG. 6A. Once fully inserted so that the inner side of the housing 30′ abuts against the outer side of the ladder's respective side rail, the crank 86 is rotated to axially contract and radially expand the scissor linkage 84, thus forcing the pads 92, 94 into frictional abutment against the inner surface of the hollow rung at diametrically opposing points thereof. Like the other rung inserts, this radial expansion against the interior of the hollow rung thus secures the extension/retraction unit to the ladder. As the grip pads 92, 94 come into contact with the inner surface of the hollow rung, continued turning of the crank 86 will attempt to draw the threaded rod 60′ further through the housing to the outer side thereof. A rubber bushing 98 is positioned around the rod 60′ between the crank 86 and the outer side of the housing 30′ so that this continued turning of the crank as the pads tighten against the rung's inner surface will cinch the housing 30′ tight against the outer side of the ladder's side rail. The grip pads 92, 94 may feature rubber or other resilient material thereon to likewise provide some give during the tightening process.

If removal of the unit is desired, rotation of the crank 86 in the opposite direction will displace the internally threaded member 88 in the reverse direction along the threaded rod 60′ toward the free end 60a thereof. This radially collapses the scissor linkage, thereby withdrawing the grip pads 92, 94 from their frictional engagement against the inner surface of the ladder rung, thus allowing withdrawal of the rung insert and removal of the overall unit from the ladder.

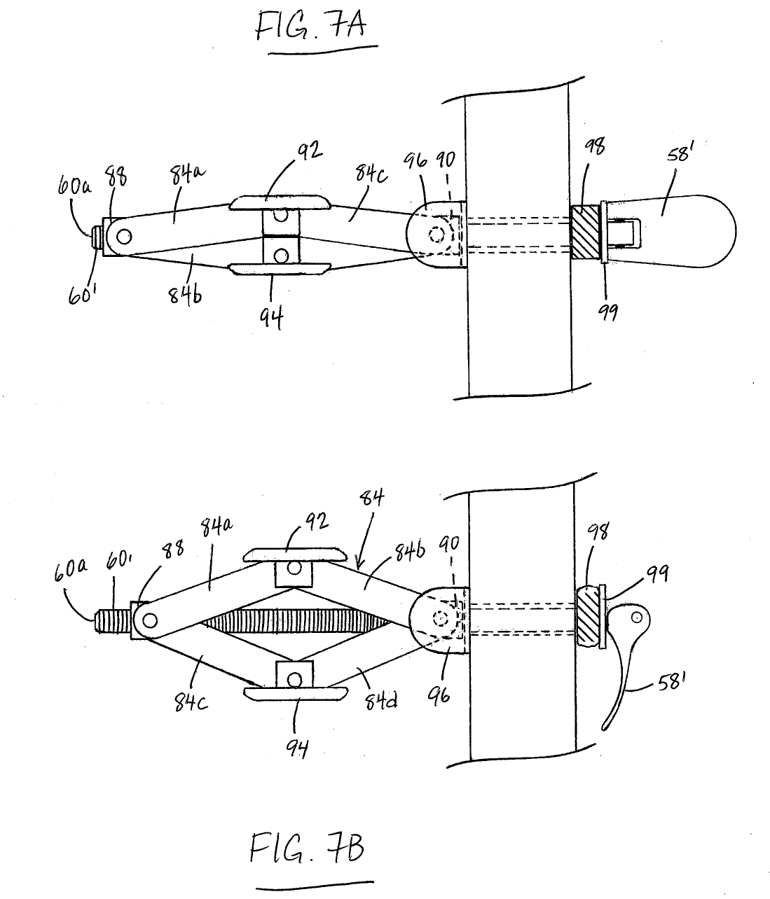

FIGS. 7A and 7B show another variation of the radially expandable rung insert, which once again uses the threaded rod 60′, scissor linkage 84 and associated threaded and non-threaded members 88, 90 to radially expand and collapse the scissor linkage under rotation of the threaded rod 60′ in opposing directions. However, instead of a crank, a cam lever 58′ is operably coupled to the threaded rod at the outer side of the housing. During a first-time installation on a ladder, with the cam-lever in its open/release position of FIG. 7A, the cam-lever is rotated about the axis of the threaded rod 60′ to cause axial contraction and radial expansion of the scissor linkage 84 inside the ladder rung. With the grip pads somewhat tightened against the inside of the ladder rung by this radial expansion of the linkage, a final tightening action is performed by pivoting the cam lever over-center into its closed position of FIG. 7B.

During this process, a cam-action of the lever 58′ acting against a washer 99 at the outer side of the bushing 98 draws the threaded rod 60′ further through the housing 30′ toward the outer side thereof, thus pulling the threaded member 88 at the distal end of the linkage 84 toward the proximal end of the linkage at which the non-threaded member 90 is abutted against the inner side of the housing. This action thereby performs an additional degree of axial contraction, and thus radial expansion, of the scissor linkage 84, thereby further tightening the grip pads 92, 94 against the rung's inner surface. In summary, this first-time installation involves an initial tightening stage performed by rotational driving of the threaded rod 60′ by rotation of the cam lever 58′ about the rod axis, followed by a subsequent further tightening stage performed by pivotally closing the cam lever 58′ about a camming axis perpendicular to the rod axis.

To later remove the unit from the ladder, movement of the cam-lever 58′ about the camming axis back into its open/release position of FIG. 7A is sufficient to remove the tightly locked state of the scissor linkage 84 inside the ladder rung, thereby enabling withdrawal of the radially-collapsed linkage from the rung. To re-use the unit on the same ladder, re-insertion of the radially-collapsed linkage into the rung and pivotal closing of the cam lever 58′ about the camming axis is all that is required to radially re-expand the linkage 84 into a fully tightened state inside the ladder rung. Accordingly, no rotation of the cam lever and threaded rod about the rod's longitudinal axis are required for such removal and re-installation on the same ladder. Only use on a ladder of different interior rung size will require rotational action to re-adjust the degree of linkage expansion required to fit that particular rung size.

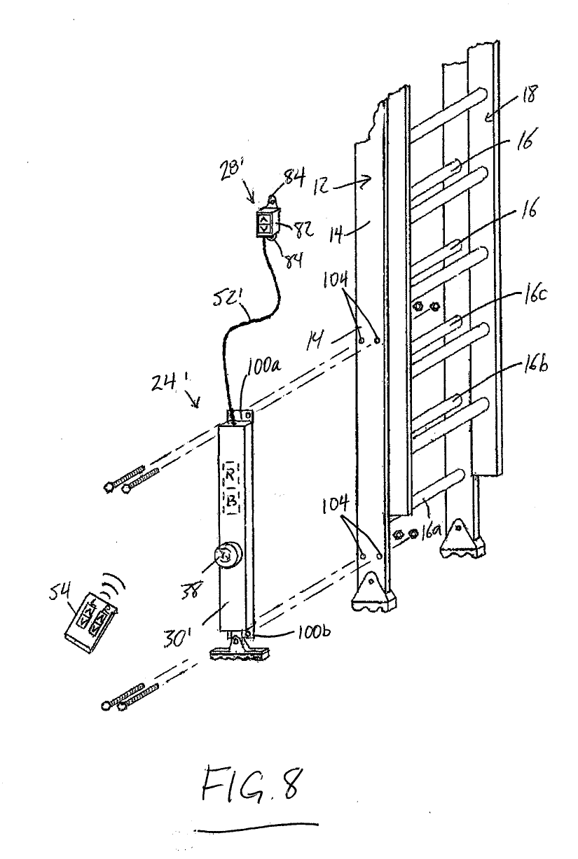

FIG. 8 shows a bolt-on embodiment of the ladder leveler where top and bottom flanges 100a, 100b reach respectively upwardly and downwardly from top and bottom ends of the housing 30′ and have fastener holes therein by which the housing can be fastened by bolts 102 to the respective side rail at matching fastener holes drilled 104 therein by the installer. While such bolt-on installation is less convenient relative to the forgoing quick-attach embodiment, it enables use on a variety of ladder types regardless of whether the rungs are hollow and open-ended, or have a solid or closed-end design and may be more cost effective.

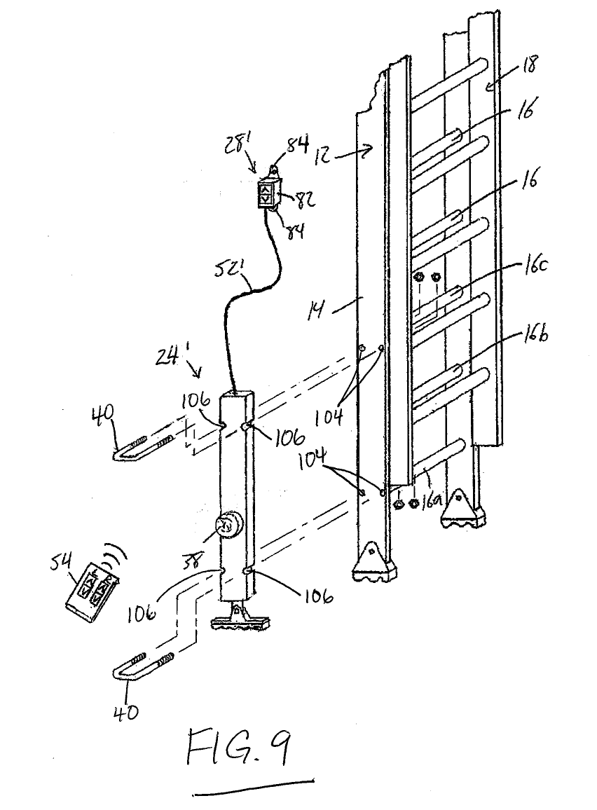

FIG. 9 shows another bolt-on variant of the ladder leveler where notches or slots 106 are recessed into the front and back of the housing 30″ in respective pairs near the top and bottom ends thereof. Each notch or slot spans fully across the housing from the inner to outer side. Each pair of notches/slots 106 near the respective end of the housing accommodates the two parallel legs of a respective U-bolt 40, the central span of which braces around the outer side of the housing.

Tightening of the U-bolt 40 through a pair of corresponding installer-drilled fastener holes 104 in the side rail of the ladder secures the housing 30″ against the outer side of the ladder's side rail. Once again, this bolt-on solution can be used on any ladder regardless of whether it has hollow open ended rungs or solid/closed-end rungs.

FIGS. 3, 8 and 9 each show only a single extension/retraction unit, but a second matching unit may likewise be installed at the opposing side rail of the ladder to enable extension and retraction of both side rails. Alternatively, a singular unit may be sufficient, whereby levelling of a ladder is performed by switching which of the side rails the extension/retraction unit and associated control is installed on according to which side rail of the ladder is situated at a lower-elevation one of the uneven ground surfaces at which the ladder will be used. The quick-attachment options of FIGS. 3 to 7 provide easier and more convenient switching of the extension/retraction unit from one leg to the other due to the tool-free quick-attach function, but the bolt-on unit of FIG. 8 or 9 may likewise be switched between two side rails having suitable fastener holes 104 by simply using a conventional wrench or fastener to undo the bolts at one side rail and re-fasten them at the other. Alternatively, it may be possible to use a single unit without having to swap it from one side rail to the other by flipping the ladder around into an appropriately facing orientation so that the unit-equipped side rail of the ladder is situated at the lower elevation ground surface.

In summary, the disclosed embodiments each provide a means of leveling a ladder on an uneven surface by using an electrically powered motorized mechanism that is either built into a ladder or added to the rails of an existing ladder in order to effect and maintain a level orientation. The actuator has a foot that is at the same level as, or retracted slightly upwardly from, the feet of the existing ladder. In the case where there is an uneven surface and one side rail of the ladder is lower than the other, the actuator on the low side may be extended in order to achieve a level ladder position. The actuators are battery powered and a momentary switch, either on the ladder or on a remote control, or both, is used to selectively provide power of the appropriate polarity to the appropriate actuator such as to cause it to go up or down, as the case may be. This provides a simple and quick way to level a ladder over and over again with very little effort on the part of the operator.

Since the battery is not required to maintain the feet positions of the actuators, the power requirements are minimal and the battery could be made smaller and likely easily hidden inside the rung(s) of the ladder. When needed, the ladder leveling operation is performed by a motorized mechanism powered by a battery or other power source, but otherwise the ladder operates as normal. The motor and battery unit can be built into the ladder during manufacturing or added as an add-on to one or more sides of the ladder. The disclosed add-on units are attached to a ladder using a quick connect method utilizing the hollow rungs of the ladder, or by a bolted or other attachment to the rails that does not limit use to hollow-rung ladders. The adjustments to the effective rail length of the ladder can be done easily with the touch of a button as opposed to having to crank, or pull-down, or release a pin, or otherwise perform two-handed adjustment of a ladder's side rail. The leveling can be performed remotely from the ladder if need be via suitable remote control, whether wired or wireless. The battery or power source is not required to maintain the ladder leveler's feet positions, as power is only required to change them. As outlined above, tilt detection and control circuitry that could be easily added to the powered ladder such that the ladder would automatically level itself. The forgoing embodiments thus provide a simple and quick method of leveling a ladder over and over again with very little effort on the part of the operator.

Since various modifications can be made in my invention as herein above described, and many apparently widely different embodiments of same made, it is intended that all matter contained in the accompanying specification shall be interpreted as illustrative only and not in a limiting sense.

1. A ladder leveling apparatus for a ladder comprising a pair of side rails and a series of rungs spanning between said side rails at spaced intervals therealong, said leveling mechanism comprising:
at least one electric linear actuator comprising a respective electric motor operable in opposing directions to drive extension and retraction of an output shaft of said electric linear actuator to which a respective ground engagement foot is attached at a distal end of said output shaft, said at least one electric linear actuator being attached or attachable to a respective side rail of the ladder in a position placing the respective ground engagement foot proximate a lower end of the respective side rail when the respective output shaft is in a retracted position, such that extension of the output shaft from said retraced position displaces the ground-engaging foot downwardly past the lower end of the respective side rail;
at least one battery unit mounted or mountable to said ladder and connected or connectable to said at least one electric linear actuator to control extension and collapse thereof; and
a control system operable to control extension and retraction of the at least one linear actuators.

2. The apparatus of claim 1 wherein the control system comprises at least one wired or wireless control respectively mounted or mountable to said respective side rail of the ladder and connected or connectable in a control circuit with said at least one battery unit and said at least one electric linear actuator to control extension and retraction thereof.

3. The apparatus of claim 1 wherein the control system comprises at least one momentary rocker switch with a neutral off position, and two momentary on positions corresponding to extension and retraction of the electric linear actuators.

4. The apparatus of claim 2 wherein said at least one control is mounted to the respective side rail of the ladder at an exterior side thereof opposite the rungs.

5. The apparatus of claim 2 wherein said at least one control is mounted to the respective side rail of the ladder at a location nearer to the bottom end of the side rail than to an opposing top end thereof.

6. The apparatus of claim 2 wherein said at least one control is mounted to the respective side rail of the ladder at a location within six feet of the bottom end thereof.

7. The apparatus of claim 1 wherein said at least one battery unit comprises support straps for closure around a respective rung of the ladder to mount said at least one battery unit to said respective rung in a position therebeneath.

8. The apparatus of claim 1 wherein said at least one battery unit is mounted to a respective rung of the ladder.

9. The apparatus of claim 8 wherein said at least one battery unit is mounted to said respective rung in a position residing beneath said respective rung and leaving a topside thereof unobstructed for stepping access thereto by a user.

10. The apparatus of claim 8 wherein control circuit wiring from said at least one battery unit to said at least one electric linear actuator extends from said battery unit along the respective rung to the respective side rail of said at least one electric linear actuator.

11. The apparatus of claim 10 wherein said control circuit wiring runs upwardly along an inner side of said respective rail from said respective rung.

12. The apparatus of claim 1 wherein said at least one electric linear actuator is coupled to the respective side rail of the ladder at an exterior side thereof by at least one U-bolt embracing around a housing of said electric linear actuator.

13. The apparatus of claim 1 wherein the at least one electric linear actuator comprises a pair of electric linear actuators that are respectively coupled to the side rails of the ladder at exterior sides thereof opposite the rungs, and are coupled together by a threaded rod passing internally through a hollow rung of the ladder.

14. The apparatus of claim 1 comprising one or more quick-attach mechanisms associated with the at least one electric linear actuator and operable for releaseable attachment thereof to the respective side rail of the ladder.

15. The apparatus of claim 14 wherein said one or more quick-attachment mechanisms comprise a rung-insert removably insertable into a hollow interior of a respective rung of the ladder.

16. The apparatus of claim 15 wherein said rung-insert is selectively expandable and collapsible in a radial direction to enable attachment of the at least one electric linear actuator to the respective rung by insertion of the rung-insert into said respective rung, and radial expansion of said rung-insert once inside said respective rung to frictionally engage with internal wall surfaces of said respective rung.

17. The apparatus of claim 15 wherein said at least one electric linear actuator comprises a pair of electric linear actuators that are respectively coupled to the side rails of the ladder, said one or more quick-attach mechanism comprise a pair of quick attach mechanisms respectively associated with the pair of electric linear actuators and each having a respective rung insert, and a length of each rung-insert is less than half a rung-width of said ladder to enable insertion of the rung-inserts of the quick-attach mechanisms into a same rung from opposing ends thereof.

18. The apparatus of claim 2 wherein the at least one control is respectively connected to the at least one linear actuator by a flexible cord or wireless connection allowing selective mounting of the control at a user selectable position along the respective side rail.

19. The apparatus of claim 1 wherein said at least one electric linear actuator comprises a pair of electric linear actuators that are respectively coupled to the side rails of the ladder and said at least one battery unit comprises a pair of batteries respectively attached to, our housed together with, the pair of electric linear actuators, whereby mounting of said pair electric linear actuators to the side rails of the ladder also mounts the batteries to said rails of the ladder.

20. The apparatus of claim 1 wherein the control system comprises a remote control operable to send control signals to the first and second linear actuators for wireless control thereof at a distance from the ladder.
